(19) United States
(12) Patent Application Publication
(10) Pub. No.: US 2026/0037396 A1
(43) Pub. Date: Feb. 5, 2026

(54) A CLUSTER-BASED LOAD SHARING AND BACKUP METHOD AND APPARATUS

(71) Applicant: TMLAKE (BEIJING) TECHNOLOGY CO., LTD., Beijing (CN)

(72) Inventors: Yangang ZHAO, Beijing (CN); Mengjiao LIAO, Beijing (CN)

(21) Appl. No.: 18/868,940

(22) PCT Filed: Feb. 2, 2024
(86) PCT No.: PCT/CN2024/075461

§ 371 Date: Nov. 25, 2024

(30) Foreign Application Priority Data
Feb. 17, 2023 (CN) 202310129009.1

(51) Int. Cl. G06F 11/20

(52) U.S. Cl. CPC G06F 11/2023; G06F 2201/81

(57) ABSTRACT

A cluster-based load sharing and backup method and apparatus is provided. The method includes: periodically monitoring clusters, and determining a healthy cluster group and an unhealthy cluster group according to the health conditions of the clusters; according to the weights and the priorities of the clusters, carrying out load sharing and backup on the traffic of the unhealthy cluster group to the healthy cluster group; receiving and analyzing a client request to obtain an execution task, and determining a target cluster from the healthy cluster group, and a target server node; and sending the execution task to the target server node in the target cluster for execution, and returning an execution result, wherein load sharing and backup comprise performing inter-cluster load sharing and backup, and intra-cluster load sharing and backup according to the health states of the clusters and server nodes in the clusters.

### CROSS-REFERENCE TO RELATED APPLICATIONS

This application is a national stage of PCT Application No. PCT/CN2024/075461, having a filing date of Feb. 2, 2024, which is based on CN application Ser. No. 202310129009.1, having a filing date of Feb. 17, 2023, the entire contents both of which are hereby incorporated by reference.

### FIELD OF TECHNOLOGY

This following relates to the technical field of databases, and in particular, to a cluster-based load sharing and backup method and apparatus.

### BACKGROUND

The load balance and the English name are Load Balance, meaning that the same type of load (work task) is balanced and shared to a plurality of operation units for operation, for example, an FTP server, a Web server, an enterprise core application server and other main task servers, so as to cooperatively complete work tasks.

Load balancing is built on the original network structure, which provides a transparent and cheap and effective method for expanding the bandwidth of the server and the network device, enhancing the network data processing capability, increasing the throughput, and improving the availability and flexibility of the network.

Enterprises often establish different server clusters based on service classification or disaster recovery requirements. At present, load balancing algorithms can only perform load balancing on hosts at the rear ends of the same cluster, but cannot perform inter-cluster load balancing among hosts at the rear ends of different clusters, that is, health monitoring, grouping and selection are performed on a plurality of clusters according to a load balancing algorithm, a cluster health state, a cluster backup mode and a traffic sharing mode, and then host selection is performed in the cluster through a secondary load balancing algorithm. The application mode of load balancing is divided into two types: traffic sharing and cluster backup. The cluster backup mode includes a master mode, a master mode, a 1: N backup mode, an N: 1 backup mode and an M: N backup mode, and automatic switching between the two centers can be flexibly achieved through these cluster backup modes. The traffic sharing mode may share traffic among a plurality of primary clusters according to factors such as geographic location, weight, and client classification.

In summary, how to perform load balancing, traffic sharing and backup among the clusters for a plurality of clusters is a technical problem urgently to be solved in the whole industry.

Based on this, it is necessary to introduce a new method and apparatus, which can perform inter-cluster load balancing, traffic sharing and backup on a plurality of clusters according to a load balancing algorithm, a cluster health state, a cluster backup mode, and a traffic sharing mode, so as to solve the technical problems in the conventional art that inter-cluster load balancing, traffic sharing and backup cannot be implemented for a plurality of clusters, thereby improving the efficiency of load balancing among multiple clusters, and the workload, reliability and data security of the cluster.

### SUMMARY

An aspect relates to a cluster-based load sharing and backup method and device. By periodically monitoring a cluster, load sharing and backup are performed on the traffic of the unhealthy cluster group to the health cluster group according to the weight and priority of the cluster, thereby solving the technical problems in the conventional art that inter-cluster load balancing, traffic sharing and backup cannot be implemented for a plurality of clusters, thereby improving the efficiency of inter-cluster load balancing, and the workload, reliability and data security of the cluster.

Embodiments of the present invention provide a cluster-based load sharing and backup method, the method comprising:
S 101, periodically monitoring a cluster, and determining a health cluster group and an unhealthy cluster group according to the health condition of the cluster;
S 102, performing load sharing and backup on the traffic of the unhealthy cluster group to the health cluster group according to the weight and priority of the cluster; and
S 103, receiving and parsing a client request to obtain an execution task, and determining a target cluster and a target server node from the health cluster group:
S 104, sending the execution task to the target server node in the target cluster for execution, and returning an execution result:

The load sharing and backup include inter-cluster load sharing and backup, and load sharing and backup in the cluster according to the health states of the server nodes in the cluster and the cluster.

As described above, S 101, periodically monitoring the cluster, and determining the health cluster group and the unhealthy cluster group according to the health condition of the cluster includes:
initializing the weights and priorities of the server nodes in the cluster and the cluster, and dividing the clusters into two groups according to the number of survival numbers of the server nodes in the cluster and a preset minimum survival number threshold, which are respectively a health cluster group and an unhealthy cluster group:
wherein the preset minimum survival number threshold is set according to the total number of server nodes in the cluster and the minimum survival ratio,
preset minimum survival number threshold=total number of server nodes in the cluster*minimum survival ratio,

Alternatively, the service needs to be set according to a service requirement.

As described above, the step of dividing the cluster into two groups according to the number of survival of the server nodes in the cluster and a preset minimum survival number threshold includes:
1) periodically counting the number of server nodes in the cluster, and comparing with the preset minimum survival number threshold to mark the health status of the cluster; and
if the number of the server nodes is greater than or equal to the preset minimum survival number threshold, marking the cluster as a health cluster, and dividing the health cluster into the health cluster group; and if the number of the server nodes is less than the preset minimum survival number threshold, marking the cluster as an unhealthy cluster, dividing the unhealthy cluster into the unhealthy cluster group, and performing load sharing and backup on the unhealthy cluster.

As described above, the step of periodically counting the survival quantity of the server nodes in the cluster and comparing the survival quantity of the server nodes in the cluster with the preset minimum survival number threshold, marking the health status of the cluster further includes the step of counting the survival server nodes in the cluster, specifically:
1) periodically sending a survival state monitoring broadcast notification to all server nodes in each cluster, and returning node monitoring information; and
2) determining and marking a survival state of the server node according to the node monitoring information; and
3) counting the number of server nodes in each cluster;

Wherein,
the node monitoring information includes three fields, namely a server number, a port number, and a survival state;
The survival state includes two fields, which are survival and non-storage, and are determined according to whether the server node works normally, and if the server node works normally, the survival state of the server node is marked as storage, and if the server node does not work normally, the survival state of the server node is marked as non-survival.

As described above, the inter-cluster load sharing and backup steps include:
selecting a load sharing target cluster from the health cluster group according to the cluster load backup mode between the clusters, and performing load sharing and backup on the traffic of the unhealthy cluster to the load sharing target cluster; and
Wherein,
the cluster load backup mode between the clusters includes three types: a multi-master mode, a multi-standby mode, a master mode and a multi-master mode, respectively;

When the cluster load backup mode between the clusters is multi-master: multi-standby mode,
the health cluster group is composed of a plurality of main clusters and a plurality of standby clusters, after the main cluster is marked as an unhealthy cluster, the standby cluster is selected as a load sharing target cluster, all execution tasks carried by the main cluster are migrated to the standby cluster, and the standby cluster carries and responds to a client request borne by the main cluster;

When the cluster load backup mode between the clusters is the main mode,
the health cluster group is composed of at least two master clusters, and after the master cluster is marked as an unhealthy cluster, all execution tasks carried by the master cluster are balanced and migrated to other master clusters, and the master clusters balance bearers and respond to client requests borne by the master cluster:

When the cluster load backup mode between the clusters is multi-master: one standby mode,

The health cluster group is composed of a plurality of main clusters and a standby cluster, after the main cluster is marked as an unhealthy cluster, the standby cluster is selected as a load sharing target cluster, all execution tasks carried by the main cluster are migrated to the standby cluster, and the standby cluster carries and responds to a client request borne by the main cluster. As described above, the inter-cluster load sharing and backup step further includes:

After the cluster is restored to the health cluster by the unhealthy cluster, the cluster is marked as a health cluster, and all execution tasks of the load sharing target cluster bearer and sharing and the client request are migrated back to the cluster.

As described above, the steps of load sharing and backup in the cluster are as follows:
determining a load sharing target server node according to the weights of the server nodes survival in the load sharing target cluster and the priorities; and
allocating the execution task and the client request balance of the load sharing target cluster bearer and the sharing to the load sharing target server node.

As described above, S 103, receiving and parsing the client request to obtain an execution task, and determining the target cluster and the target server node from the health cluster group are specifically as follows:
accepting the client request, and parsing the client request to obtain the execution plan; and determining a target cluster from the health cluster group according to the weight and priority of the health cluster; and
determining the target server node from the target cluster according to the weights and priorities of the server nodes.

As described above, S 104: sending the execution task to the target server node in the target cluster for execution, and returning an execution result, specifically:
sending the execution task to the target cluster, and allocating, by a master server node in the target cluster, the execution task to the target server node in a balanced manner; and
processing, by the target server node, a result to a master server node in the target cluster after the execution task is completed; and
obtaining, by the master server node in the target cluster, an execution result according to the processing result, and returning the execution result to the client.

Correspondingly, embodiments of the present invention further provides a cluster-based load sharing and backup apparatus, the apparatus comprising a health detection module, a sharing backup module, an execution determination module, and a return module;

Wherein,
the health detection module is configured to periodically monitor a cluster, and determine a health cluster group and an unhealthy cluster group according to the health condition of the cluster; and
the sharing backup module is configured to perform load sharing and backup on the traffic of the unhealthy cluster group to the health cluster group according to the weight and priority of the cluster; and
the execution determining module is configured to receive and parse a client request to obtain an execution task, and determine a target cluster and a target server node from the health cluster group;
the returning module is configured to send the execution task to the target server node in the target cluster for execution, and return an execution result; and

The load sharing and backup include inter-cluster load sharing and backup, and load sharing and backup in the cluster according to the health states of the server nodes in the cluster and the cluster.

By applying the above technical solution, embodiments of the present invention achieves the technical problems in the conventional art that load balancing, traffic sharing and backup between clusters cannot be achieved for a plurality of clusters by periodically monitoring a cluster, and according to the weights and priorities of the clusters, the technical problems in the conventional art that inter-cluster load balancing, traffic sharing and backup cannot be implemented for a plurality of clusters are solved, and inter-cluster load balancing, traffic sharing and backup are performed on a plurality of clusters according to a load balancing algorithm, a cluster health state, a cluster backup mode, and a traffic sharing mode, thereby improving the efficiency of load balancing among multiple clusters, and the workload, reliability and data security of clusters.

### BRIEF DESCRIPTION

Some of the embodiments will be described in detail, with references to the following Figures, wherein like designations denote like members, wherein:

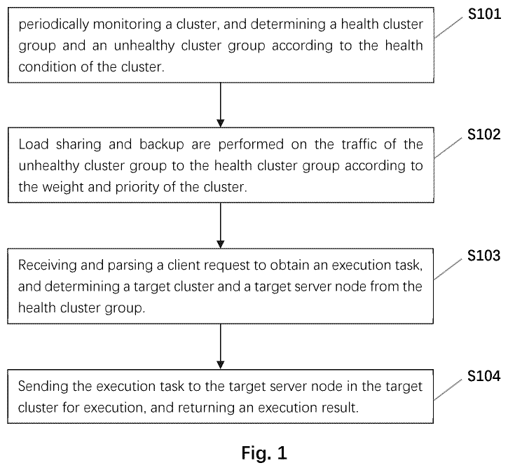

FIG. 1 is a schematic flowchart of a cluster-based load sharing and backup method according to an embodiment of the present invention; and

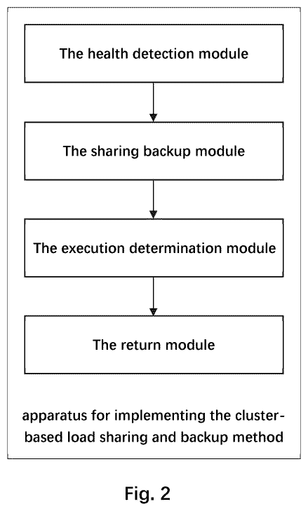

FIG. 2 is a schematic structural diagram of a cluster-based load sharing and backup apparatus according to an embodiment of the present disclosure.

### DETAILED DESCRIPTION

The following clearly and completely describes the technical solutions in the embodiments of this application with reference to the accompanying drawings in the embodiments of this application. All other embodiments obtained by a person of ordinary skill in the conventional art based on the embodiments of this application without creative efforts shall fall within the protection scope of this application.

Embodiments of the present invention provide a cluster-based load sharing and backup method, as shown in FIG. 1, the method includes the following steps:

S 101, periodically monitoring a cluster, and determining a health cluster group and an unhealthy cluster group according to the health condition of the cluster.

In an embodiment, S 101, periodically monitoring the cluster, and determining the health cluster group and the unhealthy cluster group according to the health condition of the cluster includes:
initializing the weights and priorities of the server nodes in the cluster and the cluster, and dividing the clusters into two groups according to the number of survival numbers of the server nodes in the cluster and a preset minimum survival number threshold, which are respectively a health cluster group and an unhealthy cluster group;
wherein the preset minimum survival number threshold is set according to the total number of server nodes in the cluster and the minimum survival ratio, preset minimum survival number threshold=total number of server nodes in the cluster*minimum survival ratio,

Alternatively, the service needs to be set according to a service requirement.

In an embodiment, the step of dividing the cluster into two groups according to the number of survival of the server nodes in the cluster and a preset minimum survival number threshold includes:
1) periodically counting the number of server nodes in the cluster, and comparing with the preset minimum survival number threshold to mark the health status of the cluster; and
if the number of the server nodes is greater than or equal to the preset minimum survival number threshold, marking the cluster as a health cluster, and dividing the health cluster into the health cluster group; and
if the number of the server nodes is less than the preset minimum survival number threshold, marking the cluster as an unhealthy cluster, dividing the unhealthy cluster into the unhealthy cluster group, and performing load sharing and backup on the unhealthy cluster; and

In an embodiment, the step of periodically counting the survival quantity of the server nodes in the cluster and comparing the survival quantity of the server nodes in the cluster with the preset minimum survival number threshold to mark the health condition of the cluster further includes the step of counting the survival server nodes in the cluster, specifically:
1) periodically sending a survival state monitoring broadcast notification to all server nodes in each cluster, and returning node monitoring information; and
2) determining and marking a survival state of the server node according to the node monitoring information; and
3) counting the number of server nodes in each cluster;
Wherein,
the node monitoring information includes three fields, namely a server number, a port number, and a survival state;

The survival state includes two fields, which are survival and non-storage, and are determined according to whether the server node works normally, and if the server node works normally, the survival state of the server node is marked as storage, and if the server node does not work normally, the survival state of the server node is marked as non-survival.

S 102: Load sharing and backup are performed on the traffic of the unhealthy cluster group to the health cluster group according to the weight and priority of the cluster.

The load sharing and backup include inter-cluster load sharing and backup, and load sharing and backup in the cluster according to the health states of the server nodes in the cluster and the cluster.

In an embodiment, the inter-cluster load sharing and backup step includes:
selecting a load sharing target cluster from the health cluster group according to the cluster load backup mode between the clusters, and performing load sharing and backup on the traffic of the unhealthy cluster to the load sharing target cluster; and
Wherein,
the cluster load backup mode between the clusters includes three types: a multi-master mode, a multi-standby mode, a master mode and a multi-master mode, respectively;
When the cluster load backup mode between the clusters is multi-master: multi-standby mode,
the health cluster group is composed of a plurality of main clusters and a plurality of standby clusters, after the main cluster is marked as an unhealthy cluster, the standby cluster is selected as a load sharing target cluster, all execution tasks carried by the main cluster are migrated to the standby cluster, and the standby cluster carries and responds to a client request borne by the main cluster;
When the cluster load backup mode between the clusters is the main mode,
the health cluster group is composed of at least two master clusters, and after the master cluster is marked as an unhealthy cluster, all execution tasks carried by the master cluster are balanced and migrated to other master clusters, and the master clusters balance bearers and respond to client requests borne by the master cluster;
When the cluster load backup mode between the clusters is multi-master: one standby mode,
The health cluster group is composed of a plurality of main clusters and a standby cluster, after the main cluster is marked as an unhealthy cluster, the standby cluster is selected as a load sharing target cluster, all execution tasks carried by the main cluster are migrated to the standby cluster, and the standby cluster carries and responds to a client request borne by the main cluster.

In some embodiments, the inter-cluster load sharing and backup step further includes:

After the cluster is restored to the health cluster by the unhealthy cluster, the cluster is marked as a health cluster, and all execution tasks of the load sharing target cluster bearer and sharing and the client request are migrated back to the cluster.

In an embodiment, the step of load sharing and backup in the cluster is as follows:
determining a load sharing target server node according to the weights of the server nodes survival in the load sharing target cluster and the priorities; and
allocating the execution task and the client request balance of the load sharing target cluster bearer and the sharing to the load sharing target server node.

S 103: receiving and parsing a client request to obtain an execution task, and determining a target cluster and a target server node from the health cluster group.

In an embodiment, S 103, receiving and parsing the client request to obtain an execution task, and determining the target cluster and the target server node from the health cluster group are specifically as follows:
accepting the client request, and parsing the client request to obtain the execution plan; and
determining a target cluster from the health cluster group according to the weight and priority of the health cluster; and
determining the target server node from the target cluster according to the weights and priorities of the server nodes.

S 104: Send the execution task to the target server node in the target cluster for execution, and return an execution result.

In an embodiment, S 104: sending the execution task to the target server node in the target cluster for execution, and returning an execution result, specifically:
sending the execution task to the target cluster, and allocating, by a master server node in the target cluster, the execution task to the target server node in a balanced manner; and
processing, by the target server node, a result to a master server node in the target cluster after the execution task is completed; and
obtaining, by the master server node in the target cluster, an execution result according to the processing result, and returning the execution result to the client.

By applying the above technical solution, the cluster is periodically monitored, and the health cluster group and the unhealthy cluster group are determined according to the health condition of the cluster; and performing load sharing and backup on the traffic of the unhealthy cluster group to the health cluster group according to the weight and priority of the cluster: receive and parse the client request to obtain an execution task, and determine a target cluster and a target server node from the health cluster group: sending the execution task to the target server node in the target cluster for execution, and returning an execution result, wherein the load sharing and backup comprises performing inter-cluster load sharing and backup according to the health states of the server nodes in the cluster and the cluster, and performing load sharing and backup in the cluster, According to the weight and priority of the cluster, the traffic of the unhealthy cluster group is subjected to load sharing and backup to the health cluster group, which solves the technical problems in the conventional art that inter-cluster load balancing, traffic sharing and backup cannot be realized for a plurality of clusters, thereby realizing inter-cluster load balancing, traffic sharing and backup for a plurality of clusters according to a load balancing algorithm, a cluster health state, a cluster backup mode and a traffic sharing mode, improving the efficiency of load balancing among multiple clusters, and the workload, reliability and data security of the cluster.

Corresponding to the cluster-based load sharing and backup method in the embodiments of the present invention, embodiments of the present invention further discloses a cluster-based load sharing and backup apparatus, as shown in FIG. 2, the apparatus includes a health detection module, a sharing backup module, an execution determination module, and a return module.

Wherein,
the health detection module is configured to periodically monitor a cluster, and determine a health cluster group and an unhealthy cluster group according to the health condition of the cluster; and
the sharing backup module is configured to perform load sharing and backup on the traffic of the unhealthy cluster group to the health cluster group according to the weight and priority of the cluster; and
the execution determining module is configured to receive and parse a client request to obtain an execution task, and determine a target cluster and a target server node from the health cluster group;

the returning module is configured to send the execution task to the target server node in the target cluster for execution, and return an execution result; and

The load sharing and backup include inter-cluster load sharing and backup, and load sharing and backup in the cluster according to the health states of the server nodes in the cluster and the cluster.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A cluster-based load sharing and backup method, comprising:
periodically monitoring a cluster, and determining a health cluster group and an unhealthy cluster group according to a health condition of the cluster;
performing load sharing and backup on the a traffic of the unhealthy cluster group to the health cluster group according to a weight and a priority of the cluster; and
receiving and parsing a client request to obtain an execution task, and determining a target cluster and a target server node from the health cluster group; and
sending the execution task to the target server node in the target cluster for execution, and returning an execution result:
wherenin the load sharing and backup include inter-cluster load sharing and backup, and load sharing and backup in the cluster according to health states of the server nodes in the cluster and the cluster.

2. The method according to claim 1, wherein: periodically monitoring the cluster, and determining the health cluster group and the unhealthy cluster group according to the health condition of the cluster comprises:
initializing the weights and priorities of the server nodes in the cluster and the cluster, and
dividing the clusters into two groups according to fixa number of survival numbers of the server nodes in the cluster and a preset minimum survival number threshold, which are respectively a health cluster group and an unhealthy cluster group;
wherein the preset minimum survival number threshold is set according to a total number of server nodes in the cluster and a minimum survival ratio,
wherenin the preset minimum survival number threshold is the total number of server nodes in the cluster multiplied by the minimum survival ratio, or is set according to a service requirement.

3. The method according to claim 2, wherein the dividing the cluster into two groups according to the number of survival of the server nodes in the cluster and the preset minimum survival number threshold comprises:
1) periodically counting the a number of server nodes in the cluster, and comparing with the preset minimum survival number threshold to mark the health status of the cluster; and
if the number of the server nodes is greater than or equal to the preset minimum survival number threshold, marking the cluster as a health cluster, and dividing the health cluster into the health cluster group; and
if the number of the server nodes is less than the preset minimum survival number threshold, marking the cluster as an unhealthy cluster, dividing the unhealthy cluster into the unhealthy cluster group, and performing load sharing and backup on the unhealthy cluster.

4. The method according to claim 3, wherein the step of periodically counting the survival quantity of the server nodes in the cluster and comparing the survival quantity with the preset minimum survival number threshold, marking the health status of the cluster further includes counting the survival server nodes in the clusterspe
1) periodically sending a survival state monitoring broadcast notification to all server nodes in each cluster, and returning node monitoring information; and
2) determining and marking a survival state of the server node according to the node monitoring information; and
3) counting the number of server nodes in each cluster;
wherein
the node monitoring information includes three fields, elds being a server number, a port number, and a survival state;
survival state includes two fields, which are survival and non-storage, and are determined according to whether the server node works normally, and if the server node works normally, the survival state of the server node is marked as storage, and if the server node does not work normally, the survival state of the server node is marked as non-survival.

5. The method according to claim 1, wherein the step of sharing and backing up the inter-cluster load comprises:
selecting a load sharing target cluster from the health cluster group according to the cluster load backup mode between the clusters, and performing load sharing and backup on the traffic of the unhealthy cluster to the load sharing target cluster; and
wherein
the cluster load backup mode between the clusters includes three types: a multi-master mode, a multi-standby mode, a master mode and a multi-master mode, respectively;
wherein, when the cluster load backup mode between the clusters is multi-master: multi-standby mode,
the health cluster group is composed of a plurality of main clusters and a plurality of standby clusters, after the main cluster is marked as an unhealthy cluster, the standby cluster is selected as a load sharing target cluster, all execution tasks carried by the main cluster are migrated to the standby cluster, and the standby cluster carries and responds to a client request borne by the main cluster;
wherein the cluster load backup mode between the clusters is the main mode, the health cluster group is composed of at least two master clusters, and after the master cluster is marked as an unhealthy cluster, all execution tasks carried by the master cluster are balanced and migrated to other master clusters, and the master clusters balance bearers and respond to client requests borne by the master cluster;
wherein the cluster load backup mode between the clusters is multi-master: one standby mode,
wherein the health cluster group is composed of a plurality of main clusters and a standby cluster, after the main cluster is marked as an unhealthy cluster, the standby cluster is selected as a load sharing target cluster, all execution tasks carried by the main cluster are migrated to the standby cluster, and the standby cluster carries and responds to a client request borne by the main cluster.

6. The method according to claim 5, wherein the step of inter-cluster load sharing and backup further comprises:
after the cluster is restored to the health cluster by the unhealthy cluster, the cluster is marked as a health cluster, and all execution tasks of the load sharing target cluster bearer and sharing and the client request are migrated back to the cluster.

7. The method according to claim 5, wherein the step of load sharing and backup in the cluster is as follows:
determining a load sharing target server node according to the weights of the server nodes survival in the load sharing target cluster and the priorities; and
allocating the execution task and the client request balance of the load sharing target cluster bearer and the sharing to the load sharing target server node.

8. The method according to claim 1, wherein the receiving and parsing the client request to obtain the execution task, and determining the target cluster and the target server node from the health cluster group comprises:
accepting the client request, and parsing the client request to obtain the execution plan; and determining a target cluster from the health cluster group according to the weight and priority of the health cluster; and
determining the target server node from the target cluster according to the weights and priorities of the server nodes.

9. The method according to claim 1, wherein the sending the execution task to the target server node in the target cluster for execution, and returning an execution result, comprises:
sending the execution task to the target cluster, and allocating, by a master server node in the target cluster, the execution task to the target server node in a balanced manner; and
processing, by the target server node, a result to a master server node in the target cluster after the execution task is completed; and
obtaining, by the master server node in the target cluster, an execution result according to the processing result, and returning the execution result to the client.

10. An apparatus for implementing the cluster-based load sharing and backup method according to claim 1, wherein the apparatus comprises a health detection module, a sharing backup module, an execution determination module, and a return module:
wherein
the health detection module is configured to periodically monitor a cluster, and determine a health cluster group and an unhealthy cluster group according to the health condition of the cluster; and
the sharing backup module is configured to perform load sharing and backup on the traffic of the unhealthy cluster group to the health cluster group according to the weight and priority of the cluster; and
the execution determining module is configured to receive and parse a client request to obtain an execution task, and determine a target cluster and a target server node from the health cluster group;
the returning module is configured to send the execution task to the target server node in the target cluster for execution, and return an execution result; and
the load sharing and backup include inter-cluster load sharing and backup, and load sharing and backup in the cluster according to the health states of the server nodes in the cluster and the cluster.
